(19) United States
(12) Patent Application Publication
(10) Pub. No.: US 2009/0116080 A1
(43) Pub. Date: May 7, 2009

(54) IMAGE READING APPARATUS

(75) Inventor: Hiroyuki MARUYAMA, Ishikawa (JP)

Correspondence Address: LOWE HAUPTMAN HAM & BERNER, LLP, 1700 DIAGONAL ROAD, SUITE 300, ALEXANDRIA, VA, 22314, US

(73) Assignee: PFU LIMITED, Ishikawa (JP)

(21) Appl. No.: 12/120,744

(22) Filed: May 15, 2008

(30) Foreign Application Priority Data
Nov. 6, 2007 (JP) 2007-288424

(51) Int. Cl. H04N 1/04

(52) U.S. Cl. 358/475

(57) ABSTRACT

An image reading apparatus includes a plurality of LEDs, a light guide member that linearly illuminates, an LED control circuit that controls amounts of light of each LED based on reference light quantities and corrects the reference light quantities, an image sensor such as a CCD that scans an original when each of the LEDs are put on simultaneously, an analog front end (AFE) that generates read image data corresponding to the original, and a light modulation reference member disposed at a position where imaging by the CCD is possible. During correction of each of the reference light quantities, the LED control circuit puts each LED on individually. Each LED is then modulated by correcting the present outputs based on the modulated light image data generated by sensing the light modulation reference member when each of the LEDs is on and the reference light quantities based on target outputs corresponding to each of the LEDs.

### BACKGROUND OF THE INVENTION

1. Field of the Invention

The present invention relates to an image reading apparatus, and particularly relates to an image reading apparatus that linearly illuminates a document using a plurality of LEDs and light guide members.

2. Description of the Related Art

An image reading apparatus can employ a cold cathode fluorescent lamp (CCFL) or a hot cathode fluorescent lamp (HCFL) as a light source. However, such light sources exhibit substantial variation in brightness when turned on and do not exhibit uniform variation in brightness in a main scanning direction.

Shading correction is performed by such image reading apparatuses to reduce the influence of brightness distribution in a main scanning direction of a light source and fluctuation of image-sensing elements of image sensors on images scanned by image sensors of a plurality of image-sensing elements arrayed in the main scanning direction of a document, i.e. on read image data generated by scanning. This shading correction requires white reference data based on brightness distribution of the light source in the main scanning direction.

Brightness distribution in the main scanning direction of the light source changes due to variations in brightness in conventional image reading apparatuses. White reference data for carrying out shading correction is necessary to ensure that shading correction is carried out based on actual brightness distribution in the main scanning direction of the light source. This necessitates periodic updating of the white reference data to obtain read image data without uneven concentration regardless of changes in brightness distribution in the main scanning direction of the light source due to variations in brightness by carrying out shading correction. In conventional image reading apparatuses, image sensors scan an image of a white reference plate in a situation where light is irradiated from a light source onto the white reference plate provided at a position facing the image sensors. The white reference image data is then periodically updated based on the generated white reference image data. Conventional image reading apparatuses update white reference data based on light reflected from the white reference plate.

Updating of the white reference data is carried out from directly after illumination to the start of scanning of the document, or during consecutive scanning of documents when scanning an original document (image-reading media) consecutively. The white reference data includes data corresponding to each image-sensing element. Updating is therefore very time-consuming operation because it is necessary to update data corresponding to each image-sensing element when updating the white reference data. It is therefore feared that wait time until scanning can be started will increase or that transporting of the document will have to be temporarily stopped because the updating time has become longer than the transport time for the document. Conventional image reading apparatuses update white reference data periodically and there is therefore the danger of image-reading speed being lowered.

Use of an LED (light emitting diode) as a light source in image reading apparatuses has also been proposed. Such technology is disclosed in Japanese Patent Application Laid-open No. 2000-182403. The image reading apparatus shown in the above patent application linearly illuminates a document using an LED and a light guide member. In this linear illumination, light from an LED is made to enter an end of a light guide member as a result of an LED disposed at least one of the ends in a longitudinal direction of a rod-shaped light guide member. Linear illumination of a width of the longitudinal direction of the light guide member can then be achieved by diffusing light incident to the light guide member using a diffusion member provided at the light guide member.

However, fluctuations in brightness due to changes over time also occur for the LED that is the light source of the image reading apparatus shown in the above patent application as with the cold cathode fluorescent lamp (CCFL) and hot cathode fluorescent lamp (HCFL). Fluctuations in brightness also occur until the device (LED) is thermally stable. It is therefore still necessary to update the white reference data for linear irradiation using a light guide member because brightness distribution changes in the main scanning direction.

### SUMMARY OF THE INVENTION

It is an object of the present invention to at least partially solve the problems in the conventional technology.

According to an aspect of the present invention, an image reading apparatus includes a plurality of LEDs, a light guide member that linearly irradiates light incident due to turning on of the LEDs, an LED control unit that controls light of the plurality of LEDs based on the plurality of LEDs being respectively on and off and based on reference light quantities corresponding to the plurality of LEDs, an image sensor that scans a document in a main scanning direction when the plurality of LEDs are on at the same time, a relative movement unit that scans the document in a sub-scanning direction using the image sensor by relative movement of the image sensor and the document, an image data generating unit that generates read image data corresponding to the document scanned by the image sensor, a light modulation reference member disposed at a position where scanning by the image sensor is possible, a target output storage unit that stores target outputs corresponding to the plurality of LEDs in advance, and a light correction unit that corrects the reference light quantities. During correction of each reference light quantity, the LED control unit puts the plurality of LEDs on individually, and the light correction unit modulates light of the plurality of LEDs by calculating modulated light quantities based on a present output based on modulated light image data generated by scanning the modulated light reference member when each of the LEDs are on and the stored target outputs corresponding to the LEDs that are on, and correcting the reference light quantities corresponding to the LEDs that are on based on the calculated modulated light quantities.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram showing an example of essential parts of an image reading apparatus according to a first embodiment of the present invention;

FIG. 2 is a block diagram of the image reading apparatus according to the first embodiment;

FIG. 3 is a flowchart of light modulation occurring before the image reading apparatus starts to scan an original document;

FIG. 4A is a diagram explaining light modulation of each LED;

FIG. 4B is a diagram explaining light modulation of each LED;

FIG. 4C is a diagram explaining light modulation of each LED;

FIG. 4D is a diagram explaining light modulation of each LED;

FIG. 4E is a diagram explaining light modulation of each LED;

FIG. 4F is a diagram explaining light modulation of each LED;

FIG. 5 is a flowchart of light modulation when the image reading apparatus consecutively scans a plurality of original documents;

FIG. 6 is a diagram showing an example of essential parts of an image reading apparatus according to a second embodiment of the present invention;

FIG. 7 is a block diagram of the image reading apparatus according to the second embodiment;

FIG. 8 is a flowchart of light modulation occurring while the image reading apparatus scans the original document;

FIG. 9 is a timing chart of the image reading apparatus according to the second embodiment; and

FIG. 10 is a further timing chart for the image reading apparatus according to the second embodiment.

### DETAILED DESCRIPTION OF THE PREFERRED EMBODIMENTS

Exemplary embodiments of the present invention with reference to the drawings. The present invention is not limited to the embodiments described below. The elements according to the embodiments can include or be substantially identical to elements that can be easily assumed by one skilled in the art. In the embodiments, an explanation is given of an image scanner as an image reading apparatus of the present but the present invention is not limited. Any apparatus that scans a document by image sensors such as a copier, facsimile, or character recognition apparatus is appropriate. In the embodiments, an automatic paper feed scanner is explained where an image sensor and a document are moved relative to each other by image scanning where the document is moved relative to an image sensor. The present invention is not limited, however, and is also applicable to a flat head scanner where an image sensor and a document are moved with respect to each other by moving an image sensor with respect to a document.

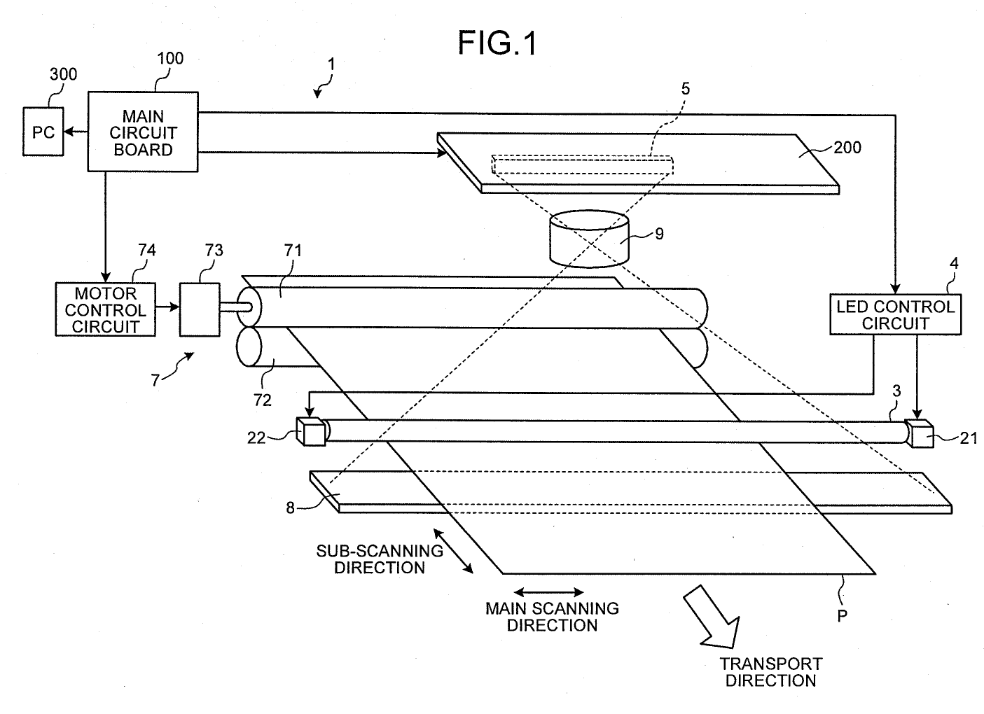

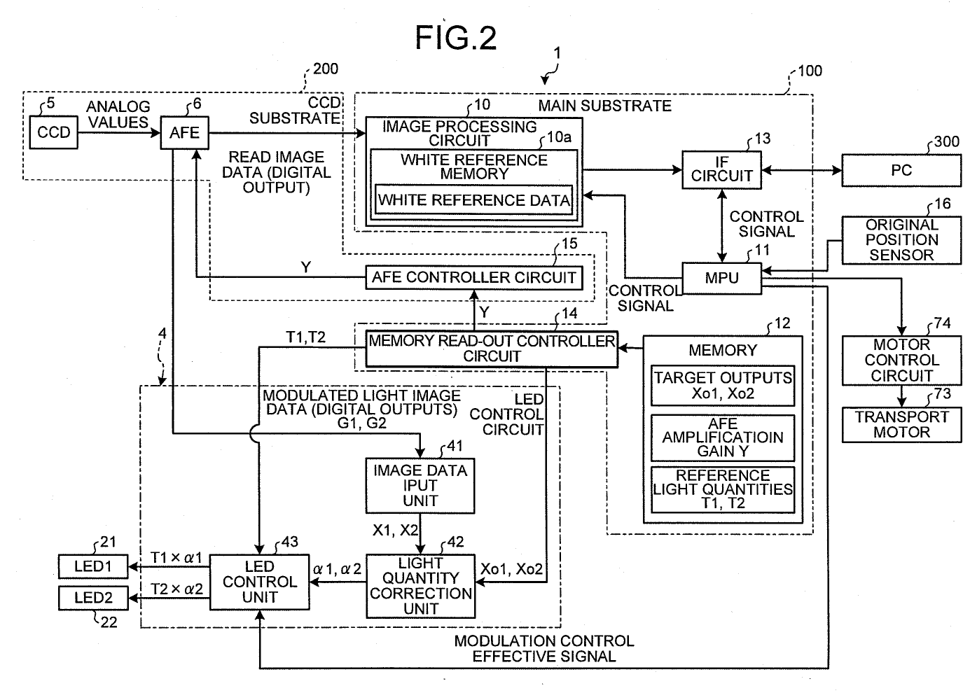

FIG. 1 is a diagram showing the essential parts of an image reading apparatus according to a first embodiment of the present invention. FIG. 2 is a block diagram of the image reading apparatus according to the first embodiment.

As shown in FIG. 1 and FIG. 2, an image reading apparatus 1 of the first embodiment has a plurality of LEDs including a first LED 21, a second LED 22, a light guide member 3, an LED control circuit 4, a CCD 5, an AFE (analog front end) 6, a transport device 7, a modulated light reference member 8, a lens 9, an image processing circuit 10, an MPU 11, a memory 12, an IF circuit 13, a memory read-out controller circuit 14, an AFE controller circuit 15, and an original position sensor 16. Numeral 100 denotes a main circuit board, numeral 200 denotes a charge-coupled device (CCD) circuit board, and numeral 300 denotes a computer (hereinafter, “PC”) that provides input instructions such as reading resolution of the original P for the document to be read in by the image reading apparatus 1 and that displays read image data generated by the image reading apparatus 1.

Two LEDs, the first LED 21 and the second LED 22, are provided as a plurality of light sources for the image reading apparatus 1 of the first embodiment. The first LED 21 and the second LED 22 are located at the ends in the longitudinal direction of the light guide member 3 facing a light irradiation direction. Light is then incident from both ends in a longitudinal direction at the light guide member 3 as a result of the first LED 21 and the second LED 22 emitting light simultaneously. The first LED 21 and the second LED 22 are high-luminance white LEDs of an output of, for example, at least 0.5 W. It is possible to change the amount of light emitted by the first LED 21 and the second LED 22 according to changes in illumination time or changes in supplied current. The plurality of LEDs can be two or more.

The light guide member 3 can irradiate linearly towards the original P or towards the modulated light reference member 8. The light guide member 3 is in the shape of a cylindrical column. When light is incident from both ends in a longitudinal direction, the incident light propagates as a result of total reflection. The first LED 21, the second LED 22, and the light guide member 3 are located on the CCD 5-side of the original P while the original P is transported to a position facing the CCD 5 by the transport device 7. A number of prisms (not shown) are also formed at the light guide member 3. The prisms of the light guide member 3 are formed so that light from the first LED 21 and the second LED 22 reflected by the prisms is irradiated from the outer surface of the light guide member 3 towards the original P while the original P is transported to a position facing the CCD 5 by the transport device 7. The light guide member 3 therefore provides linear illumination as a result of lighting of the first LED 21 and the second LED 22. When the light guide member 3 linearly irradiates incident light as a result of one LED being lit, relative brightness distribution in a longitudinal direction of the light guide member 3, i.e. in the main scanning direction, is always fixed regards of the actual amount of light of the LED. The reflection of light from the first LED 21 and the second LED 22 within the light guide member 3 can be not just a prism but also a material painted white.

The LED control circuit 4 can perform both an LED driving control and a light quantity correction. The LED control circuit 4 controls turning on and off of the first LED 21 and the second LED 22 constituting a plurality of LEDs. The LED control circuit 4 controls quantities of light of the first LED 21 and the second LED 22 based on reference light quantities T1, T2 corresponding to the first LED 21 and the second LED 22. The LED control circuit 4 also corrects the reference light quantities T1, T2 corresponding to the first LED 21 and the second LED 22. The LED control circuit 4 simultaneously puts the first LED 21 and the second LED 22 on during normal operation when the original P is scanned by the CCD 5 and corrects the reference light quantities T1, T2 corresponding to the first LED 21 and the second LED 22. The LED control circuit 4 therefore individually puts the first LED 21 and the second LED 22 on during a light-modulating operation of modulating the first LED 21 and the second LED 22. The LED control circuit 4 simultaneously puts the first LED 21 and the second LED 22 on while the CCD 5 scans the original P. The LED control circuit 4 includes an image data input unit 41, a light quantity correction unit 42, and an LED control unit 43.

Modulated light image data G1, G2 corresponding to the first LED 21 and the second LED 22 are inputted to the image data input unit 41. The image data input unit 41 is connected to the AFE 6. The image data input unit 41 is therefore inputted with the modulated light image data G1, G2 generated by the AFE 6. In the first embodiment, the items of modulated light image data G1, G2 are image data generated by the AFE 6 as a result of the modulated light reference member 8 sensing images when the CCD 5 puts just one of the first LED 21 or the second LED 22 on. Namely, the modulated light image data G1 is generated while just the first LED 21 is on, and the modulated light image data G2 is generated only while the second LED 22 is on. “Image data” is output values for each image-sensing element of the CCD 5.

The light quantity correction unit 42 also calculates modulated light quantities α1 and α2 for correcting the reference light quantities T1, T2 corresponding to the first LED 21 and the second LED 22. The light quantity correction unit 42 is connected to the image data input unit 41 and the memory read-out controller circuit 14. The items of modulated light image data G1, G2 from the image data input unit 41 and target outputs Xo1, Xo2 corresponding to the first LED 21 and the second LED 22 from the memory read-out controller circuit 14 are inputted to the light quantity correction unit 42. The light quantity correction unit 42 calculates present outputs X1, X2 based on each of the inputted modulated light image data G1, G2. The light quantity correction unit 42 calculates the modulated light quantities α1 and α2 based on the calculated present outputs X1, X2 and the present outputs X1, X2. Specifically, for example, the ratio of the target outputs Xo1, Xo2 and the present outputs X1, X2 is calculated as the modulated light quantities α1, α2 (α1=Xo1/X1, α2=Xo2/X2). The target outputs Xo1, Xo2 are outputs corresponding to specific pixels, of the image data generated by the AFE 6 by image-sensing of the modulated light reference member 8 by the CCD 5, image-scanned by the CCD 5 as a result of individually putting the first LED 21 and the second LED 22 on. This takes place under, for example, the conditions for during generation of white reference data stored in advance for carrying out shading correction. Specifically, these conditions are to put the first LED 21 and the second LED 22 on at the same time, image-scan the white reference plate using the CCD 5, have the AFE 6 generate image data, and generate white reference data based on the image data. The present outputs X1, X2 are outputs corresponding to specific image-scanned pixels of the modulated light image data G1, G2.

The LED control unit 43 controls the quantity of light for the first LED 21 and the second LED 22. The LED control unit 43 is connected to the first LED 21, the second LED 22, the memory read-out controller circuit 14 and the light quantity correction unit 42. Reference light quantities T1, T2 corresponding to the first LED 21 and the second LED 22 are inputted to the LED control unit 43 from the memory read-out controller circuit 14. Modulated light quantities α1, α2 corresponding to the first LED 21 and the second LED 22 are inputted to the LED control unit 43 from the light quantity correction unit 42. In the first embodiment, the LED control unit 43 controls the amount of light of the first LED 21 and the second LED 22 by controlling illumination times for the first LED 21 and the second LED 22 based on the reference light quantities T1, T2, or based on the reference light quantities T1×α1, T2×α2 corrected based on each of the reference light quantities T1, T2. Specifically, the LED control unit 43 controls the illumination time of the first LED 21 and the second LED 22 by controlling the duty of the first LED 21 and the second LED 22 and setting a duty ratio based on the reference light quantities T1, T2, or the corrected reference light quantities T1×α1, T2×α2. The LED control unit 43 corrects the reference light quantities T1, T2 based on calculated modulated light quantities α1, α2 when the modulated light quantities α1, α2 are calculated by the light quantity correction unit 42. For example, reference light quantities T1×α1, T2×α2 corrected by multiplying the calculated light-modulated quantities α1, α2 with each of the reference light quantities T1, T2 are calculated. The LED control unit 43 puts the first LED 21 and the second LED 22 on and off based on, for example, a modulated light control effective signal from the MPU 11.

The CCD 5 is an image sensor that scans the original P (an image-reading document) in the main scanning direction. The CCD 5 includes a plurality of image-sensing elements. A plurality of image-sensing elements are arrayed consecutively in the main scanning direction and the sub-scanning direction. Filters of either red (R), green (G), or blue (B) are provided at a plurality of image-sensing elements with filters of the same color being provided at successive image-sensing elements in, for example, the main scanning direction, and with respectively different colored filters being provided at successive image-sensing elements in the sub-scanning direction. The CCD 5 outputs analog values for each color of R, G, and B corresponding to the image-sensing elements through one-time image-scanning, i.e. each one exposure.

The AFE 6 is an image data generating unit that generates image data from scans by the CCD 5. The AFE 6 means an Analog Front End and converts analog output into digital output. The AFE 6 is connected to the CCD 5 and the AFE controller circuit 15. The AFE 6 is controlled by the AFE controller circuit 15. The AFE controller circuit 15 is connected to the memory read-out controller circuit 14. An AFE amplification gain Y is inputted to the AFE controller circuit 15 from the memory read-out controller circuit 14. The AFE 6 converts the analog value outputted by the CCD 5 into a digital output value, amplifies the converted digital output value based on the AFE amplification gain Y inputted to the AFE controller circuit 15, and generates and outputs image data from the amplified digital output. When the CCD 5 then scans the original P facing the CCD 5 and the transport device 7, the AFE 6 generates read image data corresponding to the original P from the scan of the original P by the CCD 5. The CCD 5, AFE 6, and AFE controller circuit 15 are provided on the CCD circuit board 200. The LED control circuit 4 can be provided on an independent circuit board or can be provided on the CCD circuit board 200.

The transport device 7 is a relative movement unit, and is a unit that moves the CCD 5 and the original P that is the document relatively with respect to each other. The transport device 7 transports the original P to a position facing the CCD 5, i.e. to a position where image-sensing is possible. The transport device 7 includes two transport rollers 71, 72 supported facing each other in a freely rotating manner, a transport motor 73 that is a rotation drive unit that rotates the transport roller 71, and a motor control circuit 74 that controls driving of the transport motor 73. The transport roller 71 rotates when the motor control circuit 74 is rotated by the transport motor 73. The original P is then inserted into between the transport rollers 71, 72 as a result of rotation of the transport roller 71 and is transported in the transport direction (one of the sub-scanning directions). The CCD 5 can therefore scan the original P in the sub-scanning direction by repeatedly scanning the original P in the main scanning direction while the original P is moved in the transport direction relative to the CCD 5 by the transport device 7. The motor control circuit 74 is connected to the MPU 11 and control of transporting the original P in the transport direction by the transport device 7 is carried out by the MPU 11. The MPU 11 therefore controls speed of movement of the original P by the transport device 7 with respect to the CCD 5 based on reading resolution for the original P instructed via input from the PC 300.

The modulated light reference member 8 is located at a position where image-sensing by the CCD 5 that is an image sensor is possible. The modulated light reference member 8 is a target object for image sensing during light modulation scanned by the CCD 5 while the items of modulated light image data G1, G2 are generated by the AFE 6. In the first embodiment, the modulated light reference member 8 is arranged on the opposite side to the CCD 5 from the original P while the original P is being transported up to a position opposite the CCD 5 by the transport device 7. When the original P is transported to a position facing the CCD 5 by the transport device 7, the CCD 5 scans the modulated light reference member 8 but the AFE 6 cannot generate the modulated light image data G1, G2. The modulated light reference member 8 is a white reference plate (backing) used, for example, while updating conventional white reference data.

The lens 9 causes linearly irradiated light reflected by the original P to be incident to the CCD 5. By allowing light reflected by the original P as a result of linear illumination by the light guide member 3 to pass, the lens 9 focuses the light and displays the light onto the CCD 5. The lens 9 is provided positioned between the CCD 5 and the original P transported as far as a position facing the CCD 5 by the transport device 7.

The image processing circuit 10 corrects the read image data. The image processing circuit 10 is connected to the AFE 6. Read image data generated by the AFE 6 can then be inputted to the image processing circuit 10. The correction of the read image data by the image processing circuit 10 can be, for example, shading correction. The image processing circuit 10 is a shading correction unit that carries out shading correction of the read image data. In the first embodiment, the shading correction is correction of read image data generated by the AFE 6 to read image data that does not have uneven concentration regardless of the brightness distribution in the main scanning direction of the linear irradiation by the light guide member 3 based on the white reference data. The image processing circuit 10 has a white reference memory 10a. The white reference memory 10a is a white reference data storage unit that stores white reference data in advance. The white reference data is based on brightness distribution in the main scanning direction of the linear illumination by the light guide member 3 when the first LED 21 and the second LED 22 are put on at the same time.

The MPU 11 is a microprocessing unit that controls the image reading apparatus 1. The MPU 11 is connected to the LED control unit 43 of the LED control circuit 4, the motor control circuit 74 of the transport device 7, the image processing circuit 10, the IF circuit 13, and the original position sensor 16, etc. The MPU 11 performs control based on relative position with respect to the CCD 5 of the original P, control of the first LED 21 and the second LED 22 by the LED control unit 43, control of driving of the transport motor 73 by the motor control circuit 74, and processing that corrects image data read by the image processing circuit 10, etc.

The memory 12 stores various data in advance. Data for the target outputs Xo1, Xo2, the AFE amplification gain Y, and the reference light quantities T1, T2 are stored in the memory 12 in advance. The memory 12 is a target output storage unit.

The IF circuit 13 is connected to the image processing circuit 10 and the MPU 11 and is connected to external equipment such as the image reading apparatus 1 and the PC 300 to exchange data.

The memory read-out controller circuit 14 is connected to the memory 12 and reads out data stored in advance in the memory 12. The image processing circuit 10, the MPU 11, the memory 12, the IF circuit 13, and the memory read-out controller circuit 14 are provided on the main circuit board 100.

The original position sensor 16 detects the position of the original P. The original position sensor 16 detects relative position of the original P with respect to the CCD 5. The original position sensor 16 is arranged at a location opposite the CCD 5 and the original P further in an opposite direction to the transport direction. The original position sensor 16 is connected to the MPU 11 and inputs the position of the original P relative to the CCD 5 to the main circuit board 100. The MPU 11 acquires the position of the inputted original P relative to the CCD 5. The MPU 11 then determines whether the original P is facing the CCD 5 based on the position of the original P relative to the CCD 5.

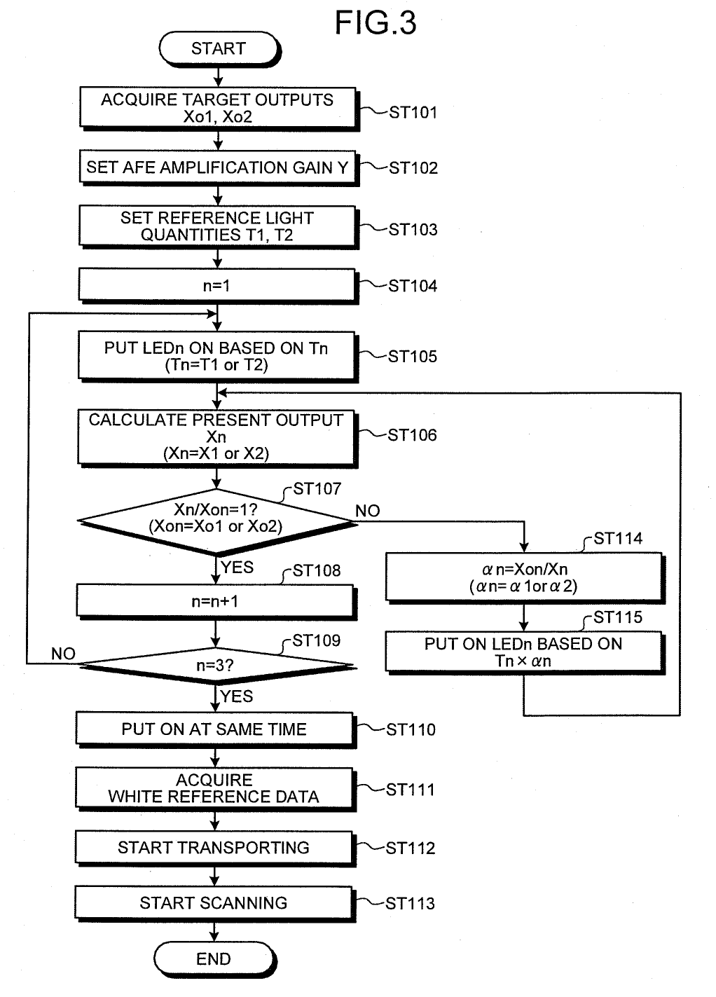

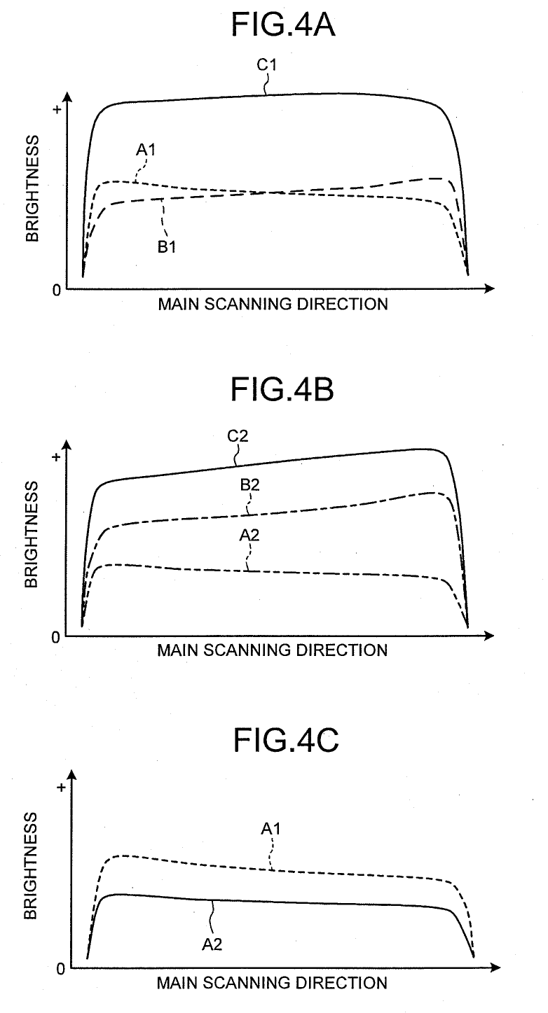

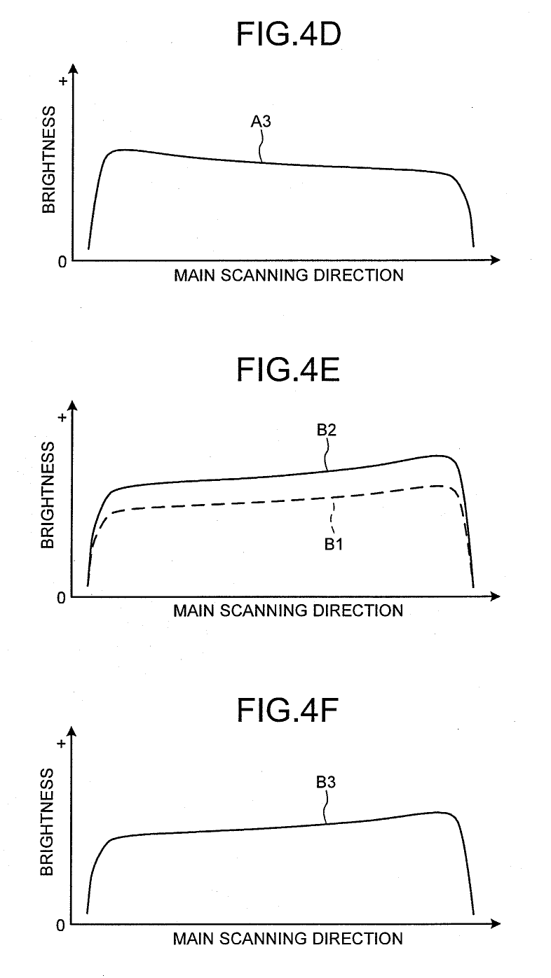

Next, the operation of the image reading apparatus 1 according to the first embodiment is explained. A light-modulating operation of the first LED 21 and the second LED 22 is explained first. FIG. 3 is a flowchart of a light-modulating operation that takes place before the image reading apparatus 1 starts to scan the original document. FIG. 4A to FIG. 4F are diagrams explaining the light-modulating operation of each of the LEDs.

The first LED 21 and the second LED 22 emit heat directly after being lit. The actual amount of light changes and fluctuation in brightness occurs until the temperature stabilizes even for the same illumination time or the same supplied current. The actual amount of light for the first LED 21 and the second LED 22 also changes as a result of changes over time such as degradation as the years pass and fluctuations in brightness therefore occur. As a result, there are cases where brightness distribution (C1 of FIG. 4A) in the main scanning direction when the light guide member 3 linearly illuminates by lighting the first LED 21 and the second LED 22 at the same time under white reference conditions and the present brightness distribution (for example, C2 of FIG. 4B) in the main scanning direction when the light guide member 3 linearly illuminates by lighting the first LED 21 and the second LED 22 at the same time are different. However, the relative brightness distribution in the main scanning direction is always fixed regardless of the actual amount of light for the LEDs. It is therefore possible to make the brightness distribution in the main scanning direction that is a reference and the present main scanning direction brightness distribution match by controlling the actual amount of light of the LEDs. It is sufficient to make the present actual quantity of light for the first LED 21 match with the actual quantity of light when the first LED 21 is put on under the white reference conditions to make the brightness distribution (A1 of FIG. 4A) in the main scanning direction when the light guide member 3 linearly illuminates by lighting just the first LED 21 under the white reference conditions and the present brightness distribution in the main scanning direction (A2 of FIG. 4B) match. It is also sufficient to make the actual quantity of light when the second LED 22 is put on under the white reference conditions and the actual present quantity of light of the second LED 22 match so that the brightness distribution (B1 of FIG. 4A) when the light guide member 3 linearly illuminates using light incident due to the second LED 22 being put on under the white reference conditions and the present brightness distribution (B2 of FIG. 4B) match.

First, the light-modulating operation by the image reading apparatus 1 before starting to scan the original P is explained. The original P is installed at the image reading apparatus 1. Before the original P is transported by the transport device 7 (when the MPU 11 determines that the original P is not facing the CCD 5 based on the relative position of the original P with respect to the CCD 5), as shown in FIG. 4, the light quantity correction unit 42 acquires each of the target outputs Xo1, Xo2 (Step ST101). The light quantity correction unit 42 then acquires each of the target outputs Xo1, Xo2 read out from the memory 12 by the memory read-out controller circuit 14.

Next, the AFE controller circuit 15 sets the AFE amplification gain Y at the AFE 6 (Step ST102). The AFE controller circuit 15 then acquires the AFE amplification gain Y read out from the memory 12 by the memory read-out controller circuit 14. As a result, the AFE amplification gain Y is set at the AFE 6 by the AFE controller circuit 15. The digital output value converted from the analog value is then amplified based on the AFE amplification gain Y. Generation of the image data from the amplified digital output value is then possible.

Next, the LED control circuit 4 sets each of the reference light quantities T1, T2 at the LED control unit 43 (Step ST103). The LED control circuit 4 acquires each of the reference light quantities T1, T2 read out from the memory 12 by the memory read-out controller circuit 14. Each of the reference light quantities T1, T2 are then set at the LED control unit 43. The illumination times of the first LED 21 and the second LED 22 are then controlled based on each of the reference light quantities T1, T2 while the first LED 21 and the second LED 22 are put on by the LED control unit 43.

Next, the MPU 11 sets n=1 (Step ST104). Here, n specifies the LED performing light modulation (the first LED 21 or the second LED 22). In the first embodiment, n=1 is the first LED 21, and n=2 is the second LED 22. A light modulating LEDn is therefore made to be the first LED 21 by setting n=1.

Next, the LED control unit 43 puts the LEDn on based on Tn (Step ST105). Tn is the reference light quantity T1 when n=1, and is the reference light quantity T2 when n=2. When n=1, the LED control unit 43 puts the first LED 21 on based on the reference light quantity T1 (A2 of FIG. 4C).

Next, the light quantity correction unit 42 calculates the present output Xn, as shown in FIG. 3 (Step ST106). Xn is the present output X1 corresponding to the first LED 21 when n=1, and is the present output X2 corresponding to the second LED 22 when n=2. The CCD 5 only puts the LEDn on when the transport device 7 has not started to transport the original P. The modulated light reference member 8 is therefore scanned with the light guide member 3 linearly illuminating as a result of only the LEDn being lit. The AFE 6 then generates light-modulating image data Gn corresponding to the LEDn. Light-modulating image data Gn generated by the image data input unit 41 is then inputted to the light quantity correction unit 42. The light quantity correction unit 42 calculates the present output Xn based on each of the inputted light-modulating image data Gn. When n=1, only the first LED 21 is put on. The light quantity correction unit 42 therefore calculates the present output X1 based on the light-modulating image data G1 corresponding to the first LED 21 inputted by the light quantity correction unit 42. Gn is the light-modulating image data G1 corresponding to the first LED 21 when n=1, and is the light-modulating image data G2 corresponding to the second LED 22 when n=2.

Next, the light quantity correction unit 42 determines whether the present output Xn and the target output Xon are the same (Step ST107). If the present output Xn and the target output Xon are the same, the present quantity of light for LEDn is the same as the quantity of light of the white reference conditions. Namely, the light quantity correction unit 42 determines whether light modulation is required for LEDn by determining whether Xn/Xon=1. When n=1, the light quantity correction unit 42 determines whether light modulation is required for the first LED 21 by determining whether X1/Xo1=1.

When the light quantity correction unit 42 determines that the present output Xn and the target output Xon are not the same (Step ST107, NO), a modulated light quantity an is calculated (Step ST114). The modulated light quantity αn is a modulated light quantity α1 corresponding to the first LED 21 when n=1, and is the modulated light quantity α2 corresponding to the second LED 22 when n=2. When it is determined that light modulation is necessary for the LEDn, the light quantity correction unit 42 calculates Xon/Xn that is a ratio of the inputted target output Xon and the calculated present output Xn as the modulated light quantity αn. Namely, the light quantity correction unit 42 calculates the modulated light quantity an at the reference light quantity Tn so that the actual present quantity of light for the LEDn matches with the actual quantity of light when just the LEDn is put on under the white reference conditions. When n=1, the light quantity correction unit 42 calculates the modulated light quantity α1 (α1=Xo1/X1) from a ratio of the target output Xo1 and the present output X1. This is performed so that the present brightness distribution (A2 of FIG. 4C) in the main scanning direction of linear illumination by the light guide member 3 when only the first LED 21 is put on based on the reference light quantity T1 matches with the brightness distribution (A1 of FIG. 4C) in the main scanning direction of the linear illumination by the light guide member 3 when only the first LED 21 is put on under the white reference conditions.

Next, the LED control unit 43 puts the LEDn on based on a reference light quantity Tn×αn corrected based on the modulated light quantity αn (Step ST115). The LED control unit 43 therefore causes the LEDn to light so that the actual light quantity for the LEDn matches the actual light quantity when only the LEDn is put on under the white reference conditions. When n=1, the LED control unit 43 puts the first LED 21 on based on the reference light quantity T1×α1 corrected based on the modulated light quantity α1 and modulates light of the first LED 21 so that the actual present quantity of light for the first LED 21 matches the actual quantity of light when only the first LED 21 is put on under white reference conditions (A3 of FIG. 4D). Namely, the LED control circuit 4 corrects the reference light quantity T1 corresponding to the put on first LED 21 and modulates the light of the first LED 21.

Next, when it is determined that the present output Xn and the target output Xon are the same (Step ST107, YES), the MPU 11 sets n=n+1 (Step ST108). When it is determined that the actual light quantity due to lighting of the LEDn based on the reference light quantity Tn or based on the corrected reference light quantity Tn×αn matches with the actual light quantity when only the LEDn is put on under white reference conditions, light modulation of the present LEDn is stopped, and light modulation of the next LEDn begins. In the above, when n=1, modulation of the light of the first LED 21 ends, and when n=2, modulation of the light of the second LED 22 begins.

Next, the MPU 11 determines whether n=3 (Step ST109). The image reading apparatus 1 is furnished with two LEDs. It is therefore determined whether light modulation is complete for all of the LEDs. In step ST108, when n=2, the MPU 11 determines that n does not equal 3 (Step ST109, NO). Step ST105 is returned to, and modulation of light of the second LED 22 is commenced.

In step ST105, the LED control unit 43 puts the second LED 22 on based on the reference light quantity T2 (B2 of FIG. 4E). Next, in step ST106, only the second LED 22 is put on. The present output X2 is then calculated based on the light-modulating image data G2 corresponding to the second LED 22 inputted by the light quantity correction unit 42. Next, in step ST108, the light quantity correction unit 42 determines whether light modulation is necessary for the second LED 22 by determining whether X2/Xo2=1. When it is determined that modulation of light of the second LED 22 is necessary (Step ST107, NO), step ST114 is proceeded to. The light quantity correction unit 42 then calculates the modulated light quantity α2 (α2=Xo2/X2) from a ratio of the target output Xo2 and the present output X2 so that the present brightness distribution, i.e. brightness distribution (B2 of FIG. 4E) in the main scanning direction of the linear illumination by the light guide member 3 when only the second LED 22 is put on based on the reference light quantity T2 matches the brightness distribution (B1 of FIG. 4E) in the main scanning direction of the linear illumination by the light guide member 3 when the second LED 22 is put on under the white reference conditions. Next, in step ST115, the LED control unit 43 puts the second LED 22 on based on the reference light quantity T1×α1 corrected based on the modulated light quantity α1. The LED control unit 43 then modulates the light of the second LED 22 so that the actual present quantity of light of the second LED 22 matches with the actual quantity of light when only the second LED 22 is put on under white reference conditions (B3 of FIG. 4F). Namely, the LED control circuit 4 corrects the reference light quantity T2 corresponding to the second LED 22 and modulates light of the second LED 22. This means that n=3 in step ST108 above. In step ST109, the MPU 11 then determines that n=3 (Step ST109, YES), and determines that light modulation is complete for all of the LEDs.

The LED control unit 43 then simultaneously puts the first LED 21 and the second LED 22 on (Step ST110). The LED control unit 43 then puts the first LED 21 on based on the reference light quantity T1 or based on the corrected reference light quantity T1×α1. The LED control unit 43 then puts the second LED 22 on based on the reference light quantity T2 or based on the corrected reference light quantity T2×α2. The present brightness distribution of the main scanning direction when the light guide member 3 linearly illuminates by simultaneously illuminating the first LED 21 and the second LED 22 therefore becomes the brightness distribution in the main scanning direction when the light guide member 3 linearly illuminates by putting on the first LED 21 and the second LED 22 at the same time under the white reference conditions (C1 of FIG. 4A).

Next, as shown in FIG. 3, the image processing circuit 10 acquires the white reference data (Step ST111). The image processing circuit 10 then acquires white reference data from the white reference memory 10a in order to perform shading correction of the read image data.

The transport device 7 then starts to transport the original P (Step ST112). The transport device 7 starts to transport the original P installed in the image reading apparatus 1 using the MPU 11 after simultaneously lighting the light-modulated first LED 21 and the second LED 22 and after the image processing circuit 10 acquires the white reference data.

Next, scanning is started by the CCD 5 (Step ST113). The CCD 5 starts to scan the original P that is transported by the transport device 7 and linearly illuminated by the light guide member 3 facing the CCD 5 in the main scanning direction and the sub-scanning direction. Read image data is then generated by the AFE 6. The image processing circuit 10 performs shading correction on the generated read image data. The shading-corrected read image data is then outputted to the PC 300 via the IF circuit 13.

It is therefore possible to make the actual present light quantities of the first LED 21 and the second LED 22 match with the actual light quantities when the first LED 21 and the second LED 22 are put on under the white reference conditions by carrying out a light-modulating operation before actual scanning of the original P is started by the image reading apparatus 1 and correcting the reference light quantities T1, T2 based on the modulated light quantities α1, α2 calculated based on the present outputs X1, X2 and the target outputs Xo1, Xo2. It is therefore possible to make the brightness distribution in the main scanning direction of the linear illumination fixed before the image reading apparatus 1 starts to scan the original P. It is further possible to correct shading with one item of white reference data based on the brightness distribution in the main scanning direction. The influence of brightness distribution of the first LED 21 and the second LED 22 can therefore be reduced even if the first LED 21 and the second LED 22 are not thermally stable and without carrying out updating of white reference data. The light-modulating operation for the first LED 21 and the second LED 22 scans the modulated light reference member 8 using the CCD 5. The light-modulating image data G1, G2 are then generated by the AFE 6. This means that only the reference light quantities T1, T2 are corrected by the LED control circuit 4, which can be achieved in a few milliseconds to a few tens of milliseconds. Image reading speed can therefore be increased compared to the few hundreds of milliseconds to a few seconds that are required in the updating of white reference data in order to update data corresponding to each of the image-sensing elements of the CCD 5 prior to the image reading apparatus 1 starting to scan the original P.

The reference light quantities T1, T2 are corrected based on the modulated light quantities α1, α2 which are in turn calculated based on the present outputs X1, X2 and the target outputs Xo1, Xo2. It is therefore possible to regulate light of the first LED 21 and the second LED 22 without using a sensor etc. to detect the actual present light quantities of the first LED 21 and the second LED 22. Nothing needs to be added to the image reading apparatus 1 in order to modulate the light of the first LED 21 and the second LED 22. The number of parts can therefore be reduced and cost reductions can be achieved.

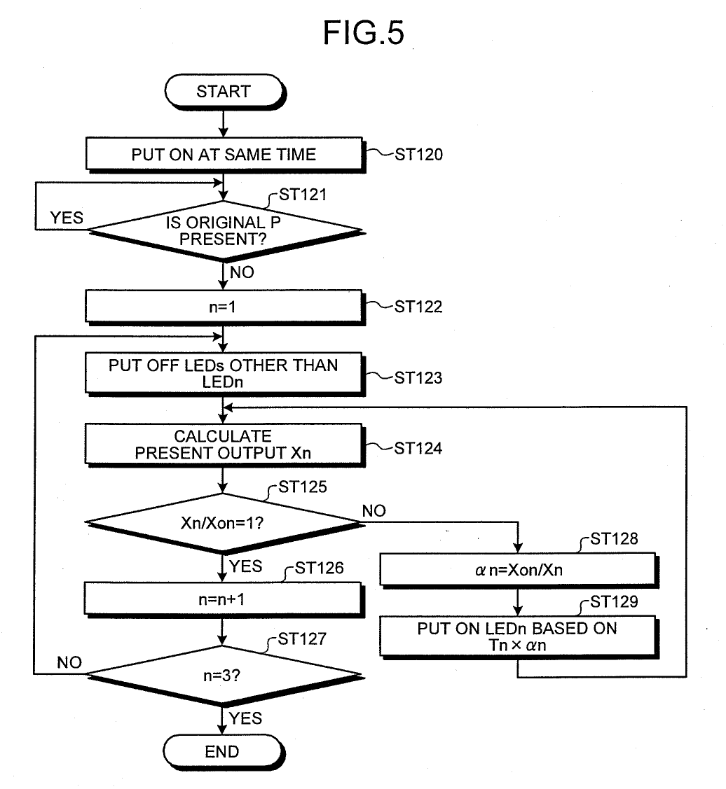

Next, a light-modulating operation when the image reading apparatus 1 consecutively scans a number of originals P is explained. FIG. 5 is a flowchart of a light-modulating operation that takes place when the image reading apparatus 1 consecutively scans a number of original documents. In contrast to the light-modulating operation occurring when scanning of the original P shown in FIG. 3 that is carried out while the image reading apparatus 1 starts the first scan of the original P, the light-modulating operation occurring at the time of consecutive scans of a number of original documents P shown in FIG. 5 takes place in a time between completion of a scan of the original P by the CCD 5 in the sub-scanning direction and the next original P being transported by the transport device 7 to a position where scanning by the CCD 5 is possible, i.e. is carried out between originals. The light-modulating operation during consecutive scans of a number of originals P shown in FIG. 5 and the light-modulating operation during the start of scanning of the original P shown in FIG. 3 are substantially the same. A detailed explanation is therefore given simplifying the same portions of the content.

First, the original P is installed in the image reading apparatus 1. The light-modulating operation for when scanning of the original P starts then ends and consecutive scanning of a number of originals P commences. With the first LED 21 and the second LED 22 put on at the same time (Step ST120), the MPU 11 determines whether or not there is an original P, i.e. determines whether the original P is moved to a position where scanning by the CCD 5 is possible (Step ST121). The MPU 11 determines whether the original P is currently being scanned by the CCD 5, i.e. whether the scanning operation by the image reading apparatus 1 is between originals, based on the relative position of the original P with respect to the CCD 5 detected by the original position sensor 16. When the MPU 11 determines that the original P is in a position where scanning by the CCD 5 is possible (Step ST121, YES), the MPU 11 repeats step ST121 until the scanning operation is between documents.

Next, when the MPU 11 determines that the original P is not in a position where scanning by the CCD 5 is possible (Step ST121, NO), then it is taken that n=1 (Step ST122), i.e. a light modulating LEDn is therefore made to be the first LED 21 by putting n=1.

Next, the LED control unit 43 puts LEDs other than the LEDn (Step ST123) off. The LED control unit 43 therefore puts LEDs other than the LEDn corresponding to the reference light quantity Tn that is corrected during correction of the reference light quantity Tn off. The LED control unit 43 therefore puts the second LED 22 off so that only the first LED 21 is put off when n=1.

Next, the light quantity correction unit 42 calculates the present output Xn, as shown in FIG. 3 (Step ST124). When n=1, only the first LED 21 is put on. The light quantity correction unit 42 therefore calculates the present output X1 based on the light-modulating image data G1 corresponding to the first LED 21 inputted by the light quantity correction unit 42.

Next, the light quantity correction unit 42 determines whether the present output Xn and the target output Xon are the same (Step ST125). When n=1, the light quantity correction unit 42 determines whether light modulation is required for the first LED 21 by determining whether X1/Xo1=1.

Next, when the light quantity correction unit 42 determines that the present output Xn and the target output Xon are not the same (Step ST125, NO), a modulated light quantity αn is calculated (Step ST128). When n=1, the light quantity correction unit 42 calculates the modulated light quantity α1 from a ratio of the target output Xo1 and the present output X1 so that the present brightness distribution of linear illumination by the light guide member 3 in the main scanning direction when only the first LED 21 is put on based on the reference light quantity T1 or the corrected reference light quantity T1×α1 matches with the brightness distribution of the linear illumination by the light guide member 3 in the main scanning direction when only the first LED 21 is put on under the white reference conditions (α1=Xo1/X1).

Next, the LED control unit 43 puts the LEDn on based on a reference light quantity Tn×αn corrected based on the modulated light quantity αn (Step ST129). When n=1, the LED control unit 43 puts the first LED 21 on based on the reference light quantity T1×α1 corrected based on the modulated light quantity α1 and modulates light of the first LED 21 so that the actual present quantity of light for the first LED 21 matches the actual quantity of light when only the first LED 21 is put on under white reference conditions. Namely, the LED control circuit 4 corrects the reference light quantity T1 corresponding to the put on first LED 21 and modulates the light of the first LED 21.

Next, when it is determined that the present output Xn and the target output Xon are the same (Step S125, YES), the MPU 11 sets n=n+1 (Step ST126). In the above, when n=1, modulation of the light of the first LED 21 ends, and when n=2, modulation of the light of the second LED 22 begins.

Next, the MPU 11 determines whether n=3 (Step ST127). In step ST126, when n=2, the MPU 11 determines that n does not equal 3 (Step ST127, NO). Step ST123 is returned to, and modulation of light of the second LED 22 is commenced.

Namely, in step ST123, the LED control unit 43 puts the first LED 21 off so that only the second LED 22 is put on. Next, in step ST124, only the second LED 22 is lit. The present output X2 is then calculated by the light quantity correction unit 42 based on the light-modulating image data G2 corresponding to the second LED 22 inputted by the light quantity correction unit 42. In step ST125, the light quantity correction unit 42 determines whether light modulation is necessary for the second LED 22 by determining whether X2/Xo2=1. Next, when it is determined that modulation of light of the second LED 22 is necessary (Step ST125, NO), in step ST128, the light quantity correction unit 42 calculates the modulated light quantity α2 from the ratio of the target output Xo2 and the present output X2 so that brightness distribution of the linear illumination by the light guide member 3 in the main scanning direction when only the second LED 22 is put on based on the current i.e. the reference light quantity T2 or the corrected reference light quantity T2×α2 matches the brightness distribution of linear illumination by the light guide member 3 in the main scanning direction when only the second LED 22 is put on under the white reference conditions (α2=Xo2/X2). Next, in step ST129, the LED control unit 43 puts the second LED 22 on based on the reference light quantity T2×α2 corrected based on the modulated light quantity α2. The LED control unit 43 then modulates the light of the second LED 22 so that the actual present quantity of light of the second LED 22 matches with the actual quantity of light when only the second LED 22 is put on under white reference conditions. Namely, the LED control circuit 4 corrects the reference light quantity T2 corresponding to the lit second LED 22 and modulates the light of the second LED 22. As a result, in step ST126, n=3. In step ST127, the MPU 11 determines that n=3 (Step ST127, YES) and determines that light modulation of all of the LEDs is complete.

It is therefore possible to make the actual present light quantities of the first LED 21 and the second LED 22 match with the actual light quantities when the first LED 21 and the second LED 22 are put on under the white reference conditions by carrying out a light-modulating operation at the time of consecutive scanning of a number of original documents P by the image reading apparatus 1 and correcting the reference light quantities T1, T2 based on the modulated light quantities α1, α2 calculated based on the present outputs X1, X2 and the target outputs Xo1, Xo2. It is therefore possible to make the brightness distribution in the main scanning direction of the linear illumination fixed between original documents during scanning of the original documents P by the image reading apparatus 1. It is further possible to correct shading with one item of white reference data based on the brightness distribution in the main scanning direction. The influence of brightness distribution of the first LED 21 and the second LED 22 can therefore be reduced even when the actual light quantities of the first LED 21 and the second LED 22 change over time, without carrying out updating of white reference data. The light-modulating operation time can therefore be made short compared to when updating the white reference data. It is therefore possible to increase image reading speed. It is also possible to modulate light of the first LED 21 and the second LED 22 between original documents when the image reading apparatus 1 scans the originals P without stopping transporting of the original P by the transport device 7.

In the first embodiment, the LED control unit 43 controls illumination time of the first LED 21 and the second LED 22 based on the reference light quantities T1, T2 or the corrected reference light quantities T1×α1, T2×α2. However, this is not limiting, and the present invention can also control the light of the first LED 21 and the second LED 22 by controlling current supplied to the first LED 21 and the second LED 22 based on the reference light quantities T1, T2 or the corrected reference light quantities T1×α1, T2×α2. In other words, modulated light of the first LED 21 and the second LED 22 is controlled by controlling the current supplied to the first LED 21 and the second LED 22 based on the reference light quantities T1, T2 or the corrected reference light quantities T1×α1 and T2×α2.

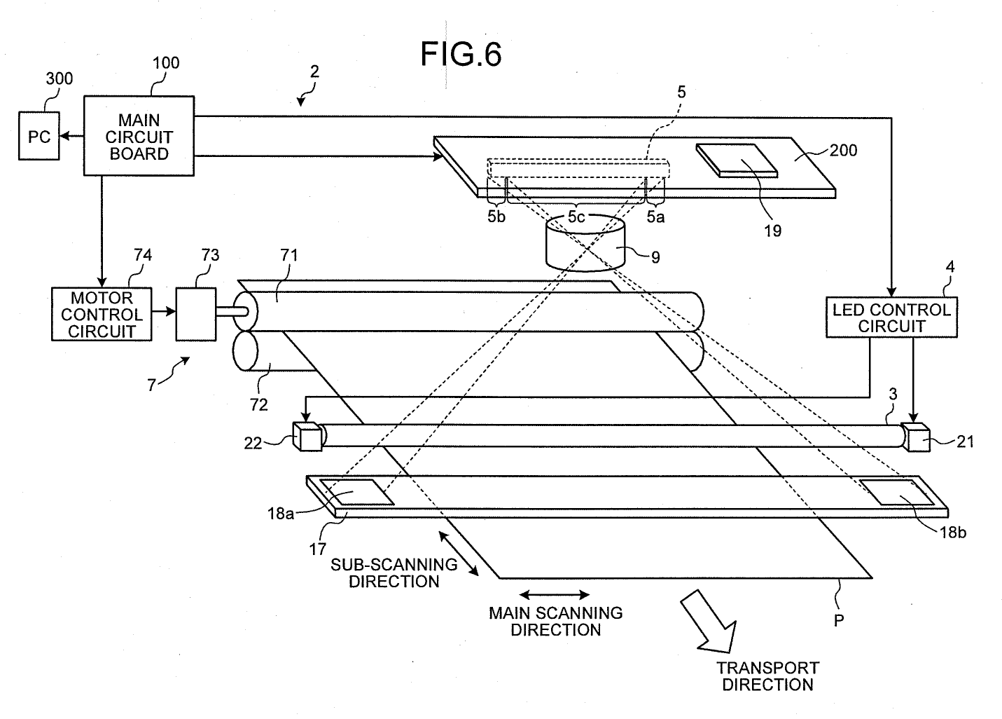

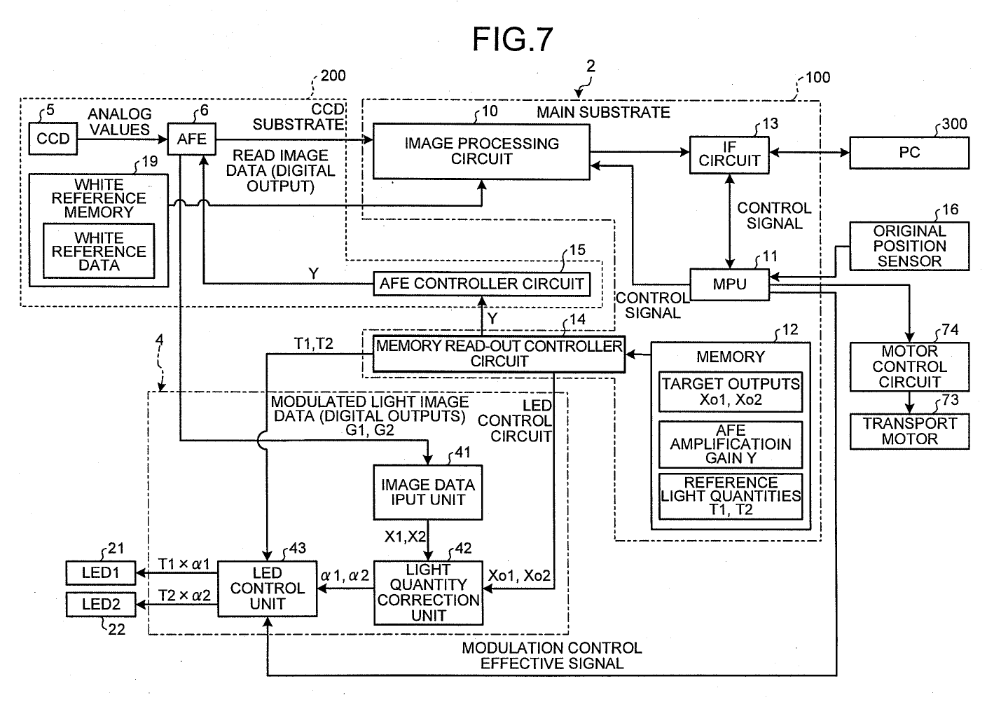

Next, an image reading apparatus 2 of a second embodiment of the present invention is explained. FIG. 6 is a diagram showing the essential parts of the image reading apparatus 2 according to the second embodiment. FIG. 7 is a block diagram of the image reading apparatus 2 according to the second embodiment. The image reading apparatus 2 of the second embodiment shown in FIG. 6 and FIG. 7 differs from the image reading apparatus 1 shown in FIG. 1 and FIG. 2 in the following way. Modulated light reference sheets 18a and 18b are located at positions where image-scanning operation can be performed by the CCD 5 within reference regions 5a and 5b, rather than a medium region 5c where the original P can be scanned when the original P is transported by the transport device 7 to a position where the original P faces the CCD 5 on the side of the CCD 5 from the original P. Further, a white reference memory 19 is integral with the first LED 21, the second LED 22, the light guide member 3, the LED control circuit 4, the CCD 5, and the AFE 6. The image reading apparatus 2 of the second embodiment is substantially the same as the image reading apparatus 1 of the first embodiment. Detailed explanations of parts that are the same are therefore omitted or simplified. As shown in FIG. 6 and FIG. 7, the image reading apparatus 2 of the second embodiment includes the first LED 21, the second LED 22, the light guide member 3, the LED control circuit 4, the CCD 5, the AFE 6, the transport device 7, the lens 9, the image processing circuit 10, the MPU 11, the memory 12, the IF circuit 13, the memory read-out controller circuit 14, the AFE controller circuit 15, the original position sensor 16, a sheet fitting member 17, the modulated light reference sheets 18a, 18b, and the white reference memory 19.

A plurality of image-sensing elements are arrayed at the CCD 5. The range capable of being scanned in the main scanning direction via the lens 9 by the plurality of image-sensing elements can therefore be made broader than the maximum width in the main scanning direction of the original P scannable by the image reading apparatus 2. The CCD 5 includes the reference regions 5a, 5b, and the medium region 5c of a plurality of image-sensing elements. The reference regions 5a, 5b are formed continuing on from either end of the medium region 5c in a longitudinal direction. Image-sensing range in the main scanning direction via the lens 9 using a plurality of image-sensing elements constituting the medium region 5c is the maximum width of the original P in the main scanning direction that can be scanned by the image reading apparatus 2. The range images can be scanned in the main scanning direction via the lens 9 using the plurality of image-sensing elements constituting the reference regions 5a and 5b, is to the outside of the maximum width of the original P in the main scanning direction that can be scanned by the image reading apparatus 2. While the CCD 5 scans the original P, line exposure time that is a one-time exposure time in a normal operation is set to be two times or more of the minimum exposure time of the CCD 5. In the second embodiment, the LED control unit 43 controls the amount of light of the first LED 21 and the second LED 22 using illumination time and sets the maximum illumination time to ½ or less of the line exposure time.

The sheet fitting member 17 is a transparent member such as a glass or resin plate. The sheet fitting member 17 is located between the original P and the CCD 5 on the CCD 5-side of the original P during transport of the original P by the transport device 7 as far as a position facing the CCD 5. When the original P is transported to a position facing the CCD 5 by the transport device 7, the CCD 5 scans images of the original P via the sheet fitting member 17.

The modulated light reference sheets 18a, 18b are located at positions capable of being scanned by the reference regions 5a, 5b of the CCD 5 that is the image sensor. The modulated light reference sheets 18a, 18b are image-sensing targets during light modulation scanned by the CCD 5 while each item of modulated light image data G1, G2 is generated by the AFE 6. In the first embodiment, the modulated light reference sheets 18a, 18b are fitted near the ends of the sheet fitting member 17 on surfaces facing the CCD 5. The CCD 5 always scans images of the modulated light reference sheets 18a, 18b even when the transport device 7 transports the original P as far as a position facing the CCD 5. It is therefore possible for the AFE 6 to generate the modulated light image data G1, G2. The target outputs Xo1, Xo2 are outputs corresponding to specific scanned pixels of the reference regions 5a, 5b of the CCD 5 of image data generated by the AFE 6 by individually lighting the first LED 21 and the second LED 22 and scanning the modulated light reference sheets 18a, 18b using the CCD 5 based on, for example, conditions during generation of white reference data stored in advance in order to carry out shading correction, i.e. lighting the first LED 21 and the second LED 22 at the same time, scanning the white reference plate using the CCD 5, having the AFE 6 generate image data, and generating white reference data based on the image data (hereinafter “white reference conditions”). Further, the present outputs X1, X2 are outputs corresponding to specific scanned pixels of the portion corresponding to the reference regions 5a, 5b of the modulated light image data G1, G2.

The white reference memory 19 is a white reference data storage unit that stores white reference data in advance. The white reference memory 19 is formed on the CCD circuit board 200 in the second embodiment. The white reference memory 19 is connected to the image processing circuit 10. The image processing circuit 10 corrects read image data generated by the AFE 6 to give read image data without uneven concentration regardless of the brightness distribution in the main scanning direction of the linear illumination by the light guide member 3 based on the white reference data of the white reference memory 19 formed on the CCD circuit board 200.

In the second embodiment, the first LED 21, the second LED 22, the light guide member 3, the LED control circuit 4, and the CCD 5, AFE 6, AFE controller circuit 15, and white reference memory 19 formed on the CCD circuit board 200 are integrated, i.e. constituted by a single unit. The white reference data differs depending on fluctuation in the characteristics of the first LED 21, the second LED 22, and the CCD 5. These elements are provided in one unit. White reference data generated using the first LED 21, the second LED 22, and the CCD 5 of this one unit can then be stored as white reference data in the white reference memory 19 on the CCD circuit board 200 in advance. This means that it is sufficient to just change the unit when there is a fault with the first LED 21, the second LED 22, or the CCD 5. It is therefore not necessary to update the white reference data and repair time when there is a fault can be made short.

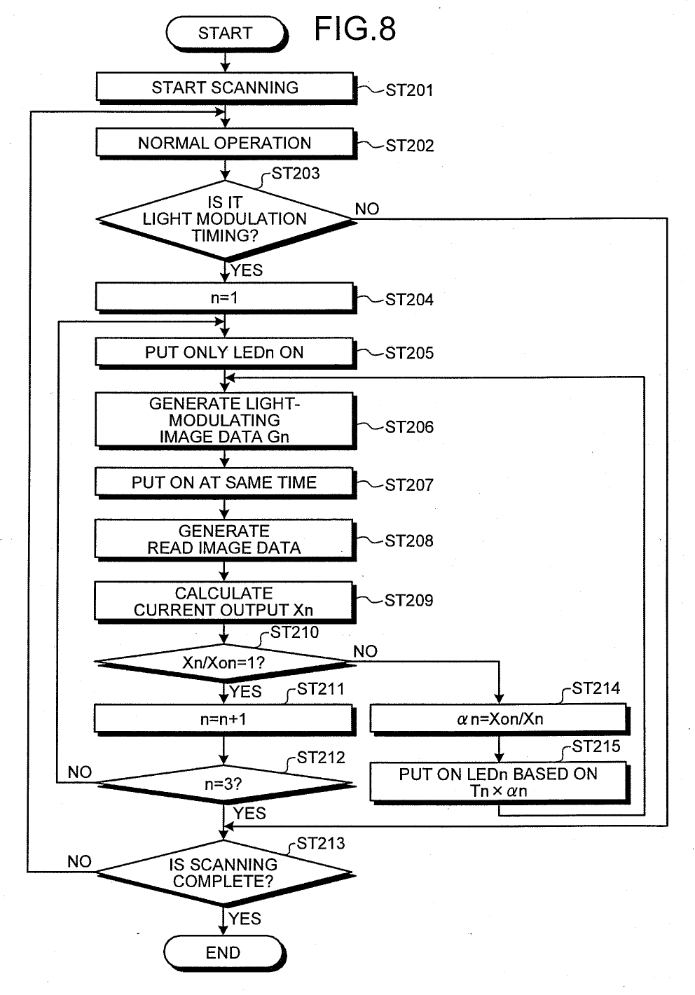

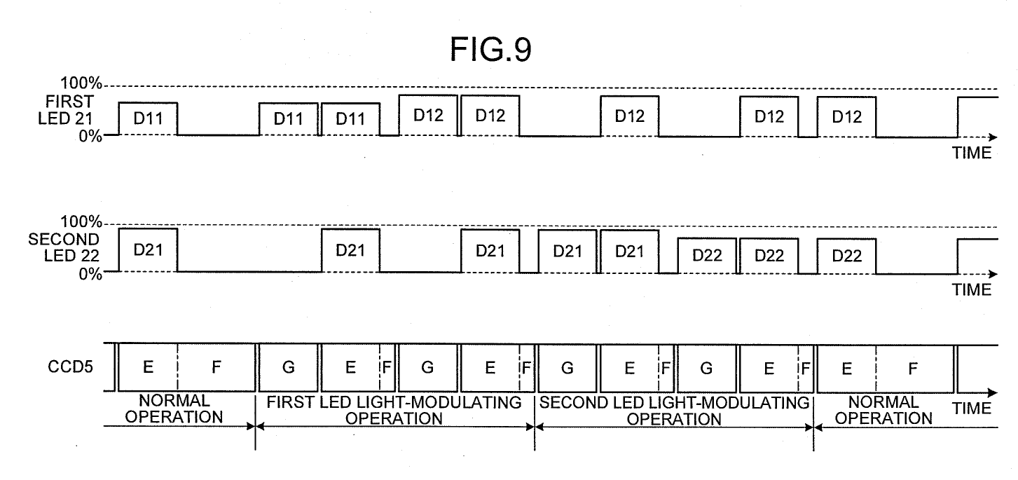

Next, the operation of the image reading apparatus 2 of the second embodiment is explained. A light-modulating operation of the first LED 21 and the second LED 22 is explained first. FIG. 8 is a flowchart of a light-modulating operation when the image reading apparatus 2 scans the original. FIG. 9 is a timing chart of the image reading apparatus 2 according to the second embodiment of the present invention. An explanation of the light-modulating operation during scanning of the original P by the image reading apparatus 2 when controlling illumination time of the first LED 21 and the second LED 22 is given. The light-modulating operation before the image reading apparatus 2 starts to scan the original P in the second embodiment is the same as the light-modulating operation before the image reading apparatus 1 of the first embodiment starts to scan the original P and is not explained here. The light-modulating operation during scanning of the original P shown in FIG. 8 and the light-modulating operation during starting of scanning of the original P shown in FIG. 3 are substantially the same. A detailed explanation is therefore given omitting or simplifying the same portions of the content.

First, the original P is installed at the image reading apparatus 2. When the light-modulating operation ends when, for example, scanning of the original P starts, the original P is transported to a position facing the CCD 5 by the transport device 7. The CCD 5 then starts scanning (Step ST201) and normal operation is carried out (Step ST202). As shown in FIG. 9, in normal operation, the first LED 21 is controlled using the duty ratio D11 set based on the reference light quantity T1 or corrected reference light quantity T1×α1. The first LED 21 is then put on for a minimum exposure time of the CCD 5 directly after starting a line exposure time. The second LED 22 is then controlled using the duty ratio D21 set based on the reference light quantity T2 or the corrected reference light quantity T2×α2. The second LED 22 is then put on for the minimum exposure time of the CCD 5 directly after starting the line exposure time. The CCD 5 is therefore exposed to light for just the line exposure time. It is therefore possible to generate read image data from analog values outputted by the CCD 5 using the AFE 6. At the CCD 5 during normal operation, the minimum exposure time portion, of the line exposure time, for directly after starting of the line exposure time is the effective pixels E for reading corresponding to the read image data generated by the AFE 6. The time from after exposure directly after starting until the line exposure time is complete is therefore for dummy pixels F that do not correspond to the read image data generated by the AFE 6.

Next, the MPU 11 determines whether it is the light modulation timing, as shown in FIG. 8 (Step ST203). The MPU 11 then determines whether it is the light modulation timing according to, for example, whether a fixed time has elapsed from starting scanning.

Next, when it is determined that it is the light modulation timing (Step ST203, YES), the MPU 11 sets n=1 (Step ST204). i.e. the light modulating LEDn is therefore made to be the first LED 21 by putting n=1 and the light-modulating operation for the first LED 21 starts from the next line exposure time after the line exposure time carried out for a normal operation elapses.

Next, the LED control unit 43 puts only the LEDn on (Step ST205). The LED control unit 43 therefore puts only the LEDn corresponding to the reference light quantity Tn that is corrected during correction of the reference light quantity Tn on. As n=1, as shown in FIG. 9, the LED control unit 43 controls the first LED 21 using the duty ratio D11 set based on the reference light quantity T1 or the corrected reference light quantity T1×α1. The LED control unit 43 then puts the first LED 21 on for the minimum exposure time of the CCD 5 directly after starting the line exposure time at the time of the light-modulating operation for the first LED 21.

Next, the AFE 6 generates light-modulating image data Gn (Step ST206) as shown in FIG. 8. The transport device 7 then starts to transport the original P. Only the LEDn is then put on with the original P facing the CCD 5. The CCD 5 is then exposed for the minimum exposure time directly after starting of the next line exposure time after elapsing of the line exposure time carried out in the normal operation with linear illumination being performed by the light guide member 3 using only the LEDn. The original P and the modulated light reference sheets 18a, 18b are scanned and the AFE 6 generates light-modulating image data Gn corresponding to the LEDn. As n=1, only the first LED 21 is on. The AFE 6 therefore generates the modulated light image data G1 corresponding to the first LED 21. As shown in FIG. 9, at the CCD 5 during the light-modulating operation, the minimum exposure time portion of the line exposure time, for directly after the start of the line exposure time, is the read valid pixels G corresponding to the light-modulating image data Gn generated by the AFE 6.

Next, as shown in FIG. 8, the LED control unit 43 simultaneously puts the first LED 21 and the second LED 22 on (Step ST207). The LED control unit 43 then puts the first LED 21 on based on the reference light quantity T1 or based on the corrected reference light quantity T1×α1. The LED control unit 43 then puts the second LED 22 on based on the reference light quantity T2 or based on the corrected reference light quantity T2×α2. As shown in FIG. 9, the LED control unit 43 controls the first LED 21 using the duty ratio D11 set based on the reference light quantity T1 or the corrected reference light quantity T1×α1. The first LED 21 is then put on for the minimum exposure time of the CCD 5 after the end of only the first LED 21 being put on directly after the start of the line exposure time during the light-modulating operation of the first LED 21. The second LED 22 is also controlled using the duty ratio D21 set based on the reference light quantity T2 or the corrected reference light quantity T2×α2. The second LED 22 is then put on for the minimum exposure time of the CCD 5 after the end of putting on just the first LED 21 directly after starting the line exposure time during the light-modulating operation of the first LED 21.

Next, the AFE 6 generates read image data (Step ST208) as shown in FIG. 8. Transporting of the original P by the transport device 7 then commences. The first LED 21 and the second LED 22 are simultaneously on with the original P facing the CCD 5. This means that linear illumination by the light guide member 3 takes place due to the first LED 21 and the second LED 22 being simultaneously on. The CCD 5 is then exposed (second exposure) for the minimum exposure time after a single exposure immediately following starting of the line exposure time during the light-modulating operation of the first LED 21. The original P and the modulated light reference sheets 18a, 18b are then scanned and the AFE 6 generates read image data corresponding to the original P. As shown in FIG. 9, at the CCD 5 during the light-modulating operation, the minimum exposure time portion, of the line exposure time, using double-exposure after a single exposure directly after starting of the line exposure time becomes the read effective pixels E corresponding to the read image data generated by the AFE 6. The time from after the second exposure to the end of the line exposure time is then for the dummy pixels F that do not correspond to read image data generated by the AFE 6. Namely, the CCD 5 is exposed to two times in one scan when correcting each reference light quantity Tn, i.e. during the light-modulating operation for the LEDn. During the light-modulating operation for the LEDn, the LED control unit 43 puts LEDn on to correct the reference light quantity Tn corresponding to LEDn at one of the two exposures for the CCD 5 (the first exposure in the second embodiment) and puts a plurality of LEDs on at the same time during the other exposure (the second exposure in the second embodiment). The AFE 6 generates light-modulating image data Gn corresponding to one of the two exposures for the CCD 5 (the first exposure in the second embodiment), i.e. corresponding to the LEDn, and generates corresponding read image data during the other exposure (the second exposure in the second embodiment).

Next, the light quantity correction unit 42 calculates the present output Xn, as shown in FIG. 8 (Step ST209). The light quantity correction unit 42 calculates the present output Xn based on portions of the light-modulating image data Gn corresponding to the reference regions 5a, 5b of the CCD 5. As n=1, only the first LED 21 is put on. The light quantity correction unit 42 therefore calculates the present output X1 based on the portion, of the light-modulating image data G1 corresponding to the first LED 21 inputted by the light quantity correction unit 42, that corresponds to the reference regions 5a, 5b of the CCD 5.

Next, the light quantity correction unit 42 determines whether the present output Xn and the target output Xon are the same (Step ST210). As n=1, the light quantity correction unit 42 determines whether light modulation is required for the first LED 21 by determining whether X1/Xo1=1.

Next, when the light quantity correction unit 42 determines that the present output Xn and the target output Xon are not the same (Step ST210, NO), a modulated light quantity an is calculated (Step ST214). When n=1, the light quantity correction unit 42 calculates the modulated light quantity α1 from a ratio of the target output Xo1 and the present output X1 so that the present brightness distribution of linear illumination by the light guide member 3 in the main scanning direction when only the first LED 21 is put on based on the reference light quantity T1 or the corrected reference light quantity T1×α1 matches with the brightness distribution of the linear illumination by the light guide member 3 in the main scanning direction when only the first LED 21 is put on under the white reference conditions (α1=Xo1/X1).

Next, the LED control unit 43 puts the LEDn on based on a reference light quantity Tn×αn corrected based on the modulated light quantity αn (Step ST215). As n=1, as shown in FIG. 9, the LED control unit 43 controls the first LED 21 using the duty ratio D12 set based on the reference light quantity T1×α1 corrected based on the modulated light quantity α1. The LED control unit 43 then puts the first LED 21 on again for the minimum exposure time of the CCD 5 directly after starting the line exposure time at the time of the light-modulating operation for the first LED 21. The first LED 21 is therefore modulated so that the actual present light quantity of the first LED 21 matches with the actual light quantity when just the first LED 21 is on under white reference conditions. Namely, the LED control circuit 4 corrects the reference light quantity T1 corresponding to the first LED 21 that is on and modulates the light of the first LED 21.

As shown in FIG. 8, the AFE 6 recreates the modulated light image data G1 (Step ST 206). The LED control unit 43 then puts the first LED 21 and the second LED 22 on again at the same time (Step ST207). The AFE 6 recreates the read image data (Step ST208). The light quantity correction unit 42 recalculates the present output X1 (Step ST209). The light quantity correction unit 42 then determines again whether the present output X1 and the target output Xo1 are the same (Step ST210). During this time, the first LED 21 controls the first LED 21 using the duty ratio D12 set based on the reference light quantity T1×α1 corrected based on the modulated light quantity α1.

Next, when it is determined that the present output Xn and the target output Xon are the same (Step ST210, YES), the MPU 11 sets n=n+1 (Step ST211). In the above, when n=1, modulation of the light of the first LED 21 ends, and when n=2, modulation of the light of the second LED 22 begins.

Next, the MPU 11 determines whether n=3 (Step ST212). In step ST211, when n=2, the MPU 11 determines that n does not equal 3 (Step ST212, NO). Step ST205 is returned to, and modulation of light of the second LED 22 is commenced.

Namely, in step ST205, the LED control unit 43 puts just the second LED 22 on. As shown in FIG. 9, the LED control unit 43 controls the second LED 22 using the duty ratio D21 set based on the reference light quantity T2 or the corrected reference light quantity T2×α2. The LED control unit 43 then puts the second LED 22 on for the minimum exposure time of the CCD 5 directly after the start of the line exposure time during modulation of the second LED 22.

The AFE 6 then generates the light-modulating image data G2 in step ST206, as depicted in FIG. 8.

Next, in step ST207, the LED control unit 43 simultaneously puts the first LED 21 and the second LED 22 on. As shown in FIG. 9, the LED control unit 43 controls the first LED 21 using the duty ratio D12 set based on the reference light quantity T1××1 corrected by the modulation of the first LED 21. The first LED 21 is then put on for the minimum exposure time of the CCD 5 after the end of illumination of only the second LED 22 directly after the start of the line exposure time during the modulation of the second LED 22. The second LED 22 is then controlled using the duty ratio D21 set based on the reference light quantity T2 or the corrected reference light quantity T2×α2. The second LED 22 is the put on for the minimum exposure time of the CCD 5 after the end of only the second LED 22 being on directly after the start of the line exposure time during modulation of the second LED 22.

Next, in step ST208, the AFE 6 generates the read image data, as shown in FIG. 8. The light quantity correction unit 42 then calculates the present output X2 based on the light-modulating image data G2 in step ST209. In step ST210, the light quantity correction unit 42 determines whether light modulation is necessary for the second LED 22 by determining whether X2/Xo2=1. Next, when it is determined that modulation of light of the second LED 22 is necessary (Step ST210, NO), in step ST214, the light quantity correction unit 42 calculates the modulated light quantity α2 from the ratio of the target output Xo2 and the present output X2 so that brightness distribution of the linear illumination by the light guide member 3 in the main scanning direction when only the second LED 22 is put on based on the current i.e. the reference light quantity T2 or the corrected reference light quantity T2×α2 matches the brightness distribution of linear illumination by the light guide member 3 in the main scanning direction when only the second LED 22 is put on under the white reference conditions (α2=Xo2/X2). Next, in step ST215, the LED control unit 43 puts the second LED 22 on based on the reference light quantity T2×α2 corrected based on the modulated light quantity α2. As shown in FIG. 9, the LED control unit 43 controls the second LED 22 using the duty ratio D22 set based on the reference light quantity T2×α2 corrected based on the reference light quantity T2. The LED control unit 43 then puts the second LED 22 on again for the minimum exposure time of the CCD 5 directly after the start of the line exposure time during modulation of the second LED 22. The first LED 21 is therefore modulated so that the actual present light quantity of the first LED 21 matches with the actual light quantity when just the first LED 21 is on under white reference conditions. Namely, the LED control circuit 4 corrects the reference light quantity T1 corresponding to the first LED 21 that is on and modulates the light of the first LED 21.

As shown in FIG. 8, the AFE 6 recreates the modulated light image data G2 (Step ST 206). The LED control unit 43 then puts the first LED 21 and the second LED 22 on again at the same time (Step ST207). The AFE 6 recreates the read image data (Step ST208). The light quantity correction unit 42 recalculates the present output X2 (Step ST209). The light quantity correction unit 42 then determines again whether the present output X2 and the target output Xo2 are the same (Step ST210). During this time, the second LED 22 controls the second LED 22 using the duty ratio D22 set based on the reference light quantity T2×α2 corrected based on the modulated light quantity α2.

Next, when it is determined that the present output Xn and the target output Xon are the same (Step ST210, YES), the MPU 11 sets n=n+1 (Step ST211).

Next, in step ST211, n=3, the MPU 11 determines that n=3 (Step ST212, YES), and it is determined that modulation of all of the LEDs is complete. The present brightness distribution of the main scanning direction when the light guide member 3 linearly illuminates by simultaneously illuminating the first LED 21 and the second LED 22 therefore becomes the brightness distribution in the main scanning direction when the light guide member 3 linearly illuminates by putting on the first LED 21 and the second LED 22 at the same time under the white reference conditions.

Next, when the MPU 11 determines that n=3 (Step ST212, YES), or determines that it is not the light modulation timing (Step ST203, NO), it is determined that the scan of the original P is complete (Step ST213). When the MPU 11 determines that scanning of the original P is complete (Step ST213, YES), operation of the image reading apparatus 1-2 is halted. When it is determined that scanning of the original P is not complete (Step ST213, NO), step ST202 is returned to and normal operation is carried out again.

It is therefore possible to make the actual present light quantities of the first LED 21 and the second LED 22 match with the actual light quantities when the first LED 21 and the second LED 22 are put on under the white reference conditions by carrying out a light-modulating operation during scanning of the original P is started by the image reading apparatus 2 and correcting the reference light quantities T1, T2 based on the modulated light quantities α1, α2 calculated based on the present outputs X1, X2 and the target outputs Xo1, Xo2. It is therefore possible to make the brightness distribution in the main scanning direction of the linear illumination fixed during the image reading apparatus 2 starts to scan the original P. It is further possible to correct shading with one item of white reference data based on the brightness distribution in the main scanning direction. The influence of brightness distribution of the first LED 21 and the second LED 22 can therefore be reduced even when the actual light quantities of the first LED 21 and the second LED 22 change over time, without carrying out updating of white reference data. It is therefore possible to modulate a plurality of LEDs while the image reading apparatus 2 scans the original P. This means that it is not necessary to pause scanning by the CCD 5 in order to update the white reference data even if the original P is long. Image reading speed can therefore be further increased. It is also possible to modulate light of a plurality of LEDs while the image reading apparatus 2 scans the original P. This means that read image data corresponding to the original P can be generated as a single item of data even when the original P is long.

In the second embodiment, the LED control unit 43 controls illumination time of the first LED 21 and the second LED 22 based on the reference light quantities T1, T2 or the corrected reference light quantities T1×α1, T2×α2. However this is not limiting, and the present invention can also control the light of the first LED 21 and the second LED 22 by controlling current supplied to the first LED 21 and the second LED 22 based on the reference light quantities T1, T2 or the corrected reference light quantities T1×α1, T2×α2. In other words, modulated light of the first LED 21 and the second LED 22 is controlled by controlling the current supplied to the first LED 21 and the second LED 22 based on the reference light quantities T1, T2 or the corrected reference light quantities T1×α1 and T2×α2.

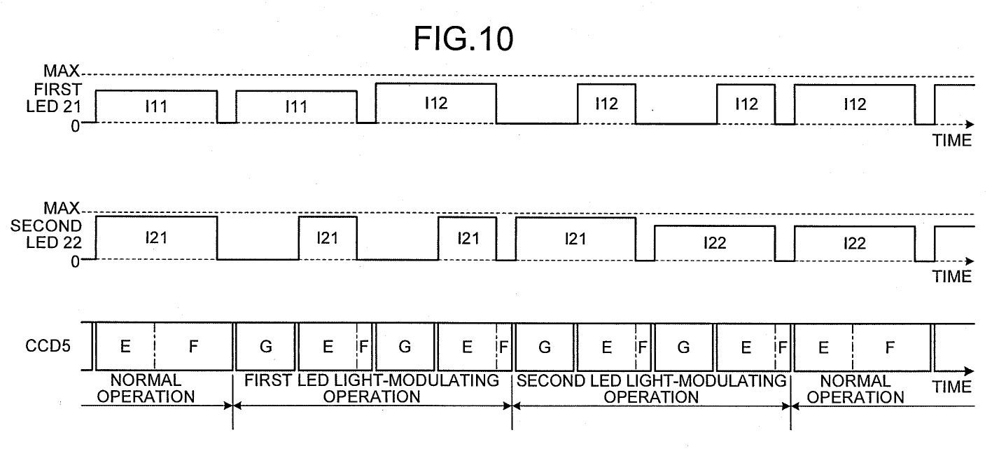

FIG. 10 is a diagram showing a further timing chart for the image reading apparatus 2 of the second embodiment. Modulation while the image reading apparatus 2 scans the original P is explained for when controlling the current supplied to the first LED 21 and the second LED 22. Modulation performed by controlling the current supplied to the first LED 21 and the second LED 22 is the same as modulation carried out by controlling illumination time of the first LED 21 and the second LED 22 shown in FIG. 8. Portions that are the same content are omitted or explained in a simplified manner using FIG. 8.

First, scanning by the CCD 5 is started (Step ST201). Normal operation is then performed (Step ST202). In normal operation, as shown in FIG. 10, the first LED 21 is controlled using a supplied current I11 set based on the reference light quantity T1 or the corrected reference light quantity T1×α1. The second LED 22 is controlled using a supplied current I21 set based on the reference light quantity T2 or the corrected reference light quantity T2×α2. Lighting takes place for a two-time portion of time of the minimum exposure of the CCD 5 directly after starting of the line exposure time. The CCD 5 is then exposed for just the line exposure time and the read image data is generated from analog values outputted from the CCD 5 by the AFE 6.

Next, the MPU 11 determines whether it is the light modulation timing, as shown in FIG. 8 (Step ST203). Next, when it is determined that it is the light modulation timing (Step ST203, YES), the MPU 11 sets n=1 (Step ST204), i.e. the light modulating LEDn is therefore made to be the first LED 21 by setting n=1 and the light-modulating operation for the first LED 21 starts from the next line exposure time after the line exposure time carried out for a normal operation elapses.

Next, the LED control unit 43 puts only the LEDn on (Step ST205). As n=1, as shown in FIG. 10, the LED control unit 43 controls the first LED 21 using a supplied current I11 set based on the reference light quantity T1 or the corrected reference light quantity T1×α1. Lighting then takes place for a time of a two-times portion of the minimum exposure time of the CCD 5 directly after starting the line exposure time at the time of the light-modulating operation for the first LED 21.

Next, the AFE 6 generates light-modulating image data Gn (Step ST206) as shown in FIG. 8. The transport device 7 then starts to transport the original P. Only the LEDn is then put on with the original P facing the CCD 5. The CCD 5 is then exposed for the minimum exposure time directly after starting of the next line exposure time after elapsing of the line exposure time carried out in the normal operation with linear illumination being performed by the light guide member 3 using only the LEDn. The original P and the modulated light reference sheets 18a, 18b are scanned and the AFE 6 generates light-modulating image data Gn corresponding to the LEDn. As n=1, only the first LED 21 is on. The AFE 6 therefore generates the modulated light image data G1 corresponding to the first LED 21.

The LED control unit 43 then simultaneously puts the first LED 21 and the second LED 22 on (Step ST207). The first LED 21 is already on and the LED control unit 43 then puts on the second LED 22 based on the reference light quantity T2 or the corrected reference light quantity T2×α2. As shown in FIG. 10, the LED control unit 43 controls the second LED 22 using the supplied current I21 set based on the reference light quantity T2 or the corrected reference light quantity T2×α2 with the first LED 21 on. The second LED 22 is then put on for the minimum exposure time of the CCD 5 after the minimum exposure time for directly after the start of the line exposure time during modulation of the first LED 21.

Next, the AFE 6 generates read image data (Step ST208) as shown in FIG. 8. Transporting of the original P by the transport device 7 then commences. The first LED 21 and the second LED 22 are simultaneously on with the original P facing the CCD 5. This means that linear illumination by the light guide member 3 takes place due to the first LED 21 and the second LED 22 being simultaneously on. The CCD 5 is then exposed (double exposure) for the minimum exposure time after a single exposure immediately following starting of the line exposure time during the light-modulating operation of the first LED 21. The original P and the modulated light reference sheets 18a, 18b are then scanned and the AFE 6 generates read image data corresponding to the original P. The time the first LED 21 and the second LED 22 are on for the same time for is halved during modulation compared to during normal operation, and output is therefore also halved. Here, the image processing circuit 10 therefore shifts the output for the read image data generated during modulation by one bit hence doubling the output in order to make the output for the read image data generated during modulation substantially the same as the output for the read image data generated during normal operation.

Next, the light quantity correction unit 42 calculates the present output Xn (Step ST209). As n=1, only the first LED 21 is put on. The light quantity correction unit 42 therefore calculates the present output X1 based on the portion, of the light-modulating image data G1 corresponding to the first LED 21 inputted by the light quantity correction unit 42, that corresponds to the reference regions 5a, 5b of the CCD 5.

Next, the light quantity correction unit 42 determines whether the present output Xn and the target output Xon are the same (Step ST210). As n=1, the light quantity correction unit 42 determines whether light modulation is required for the first LED 21 by determining whether X1/Xo1=1.

When the light quantity correction unit 42 determines that the present output Xn and the target output Xon are not the same (Step ST210, NO), a modulated light quantity an is calculated (Step ST214). When n=1, the light quantity correction unit 42 calculates the modulated light quantity α1 from a ratio of the target output Xo1 and the present output X1 so that the present brightness distribution of linear illumination by the light guide member 3 in the main scanning direction when only the first LED 21 is put on based on the reference light quantity T1 or the corrected reference light quantity T1××1 matches with the brightness distribution of the linear illumination by the light guide member 3 in the main scanning direction when only the first LED 21 is put on under the white reference conditions (α1=Xo1/X1).

Next, the LED control unit 43 puts the LEDn on based on a reference light quantity Tn×αn corrected based on the modulated light quantity αn (Step ST215). As n=1, as shown in FIG. 9, the LED control unit 43 controls the first LED 21 using a supplied current I12 set based on the reference light quantity T1××1 corrected based on the modulated light quantity α1. The LED control unit 43 then puts the first LED 21 on again for a two-time portion of the minimum exposure time of the CCD 5 directly after starting the line exposure time at the time of the light-modulating operation for the first LED 21. The first LED 21 is therefore modulated so that the actual present light quantity of the first LED 21 matches with the actual light quantity when just the first LED 21 is on under white reference conditions. Namely, the LED control circuit 4 corrects the reference light quantity T1 corresponding to the first LED 21 that is on and modulates the light of the first LED 21.

As shown in FIG. 8, the AFE 6 recreates the modulated light image data G1 (Step ST 206). The LED control unit 43 then puts the first LED 21 and the second LED 22 on again at the same time (Step ST207). The AFE 6 recreates the read image data (Step ST208). The light quantity correction unit 42 recalculates the present output X1 (Step ST209). The light quantity correction unit 42 then determines again whether the present output X1 and the target output Xo1 are the same (Step ST210). During this time, the first LED 21 controls the first LED 21 using the supplied current I12 set based on the reference light quantity T1×α1 corrected based on the modulated light quantity α1.

Next, when it is determined that the present output Xn and the target output Xon are the same (Step S210, YES), the MPU 11 sets n=n+1 (Step ST211). In the above, when n=1, modulation of the light of the first LED 21 ends, and when n=2, modulation of the light of the second LED 22 begins.

Next, the MPU 11 determines whether n=3 (Step ST212). In step ST211, when n=2, the MPU 11 determines that n does not equal 3 (Step ST212, NO). Step ST205 is returned to, and modulation of light of the second LED 22 is commenced.

Namely, in step ST205, the LED control unit 43 puts just the second LED 22 on. As shown in FIG. 10, the LED control unit 43 controls the second LED 22 using a supplied current I21 set based on the reference light quantity T2 or the corrected reference light quantity T2×α2. The LED control unit 43 then puts the second LED 22 on for a time of a two-time portion of the minimum exposure time of the CCD 5 directly after the start of the line exposure time during modulation of the second LED 22.

The AFE 6 then generates the light-modulating image data G2 in step ST206, as depicted in FIG. 8.

Next, in step ST207, the LED control unit 43 simultaneously puts the first LED 21 and the second LED 22 on. As shown in FIG. 10, the LED control unit 43 controls the first LED 21 using the supplied current I12 set based on the corrected reference light quantity T2×α2 with the second LED 22 on. Illumination for a minimum exposure time of the CCD 5 then takes place after the minimum exposure time directly after the start of the line exposure time during modulation of the second LED 22.

The AFE 6 then generates the read image data of two-times output in step ST208, as depicted in FIG. 8. The light quantity correction unit 42 then calculates the present output X2 based on the light-modulating image data G2 in step ST209. In step ST210, the light quantity correction unit 42 determines whether light modulation is necessary for the second LED 22 by determining whether X2/Xo2=1. Next, when it is determined that modulation of light of the second LED 22 is necessary (Step ST210, NO), in step ST214, the light quantity correction unit 42 calculates the modulated light quantity α2 (α2=Xo2/X2) from the ratio of the target output Xo2 and the present output X2 so that brightness distribution of the linear illumination by the light guide member 3 in the main scanning direction when only the second LED 22 is put on based on the current i.e. the reference light quantity T2 or the corrected reference light quantity T2×α2 matches the brightness distribution of linear illumination by the light guide member 3 in the main scanning direction when only the second LED 22 is put on under the white reference conditions. Next, in step ST215, the LED control unit 43 puts the second LED 22 on based on the reference light quantity T2×α2 corrected based on the modulated light quantity α2. As shown in FIG. 10, the LED control unit 43 controls the second LED 22 using a supplied current I22 set based on the reference light quantity T2×α2 corrected based on the modulated light quantity α2. The LED control unit 43 then puts the second LED 22 on again for the minimum exposure time of the CCD 5 directly after the start of the line exposure time during modulation of the second LED 22. The second LED 22 is therefore modulated so that the actual present light quantity of the second LED 22 matches with the actual light quantity when just the second LED 22 is on under white reference conditions. Namely, the LED control circuit 4 corrects the reference light quantity T2 corresponding to the second LED 22 that is on and modulates the light of the second LED 22.

As shown in FIG. 8, the AFE 6 recreates the modulated light image data G2 (Step ST 206). The LED control unit 43 then puts the first LED 21 and the second LED 22 on again at the same time (Step ST207). The AFE 6 recreates the read image data (Step ST208). The light quantity correction unit 42 recalculates the present output X2 (Step ST209). The light quantity correction unit 42 then determines again whether the present output X2 and the target output Xo2 are the same (Step ST210). During this time, the second LED 22 controls the second LED 22 using the duty ratio D22 set based on the reference light quantity T2×α2 corrected based on the modulated light quantity α2.

Next, when it is determined that the present output Xn and the target output Xon are the same (YES at Step ST210), the MPU 11 sets n=n+1 (Step ST211).

Next, in step ST211, n=3, the MPU 11 determines that n=3 (Step ST212, YES), and it is determined that modulation of all of the LEDs is complete. The present brightness distribution of the main scanning direction when the light guide member 3 linearly illuminates by simultaneously illuminating the first LED 21 and the second LED 22 therefore becomes the brightness distribution in the main scanning direction when the light guide member 3 linearly illuminates by putting on the first LED 21 and the second LED 22 at the same time under the white reference conditions.

Next, when the MPU 11 determines that n=3 (Step ST212, YES), or determines that it is not the light modulation timing (Step ST203, NO), it is determined that the scan of the original P is complete (Step ST213). When the MPU 11 determines that scanning of the original P is complete (Step ST213, YES), operation of the image reading apparatus 2 is halted. Step ST202 is returned to and normal operation is carried out again.

With the image reading apparatus of the present invention, brightness distribution in a longitudinal direction, i.e. the main scanning direction, of the light guide member is always fixed when the light guide member performs linear illumination by putting the LEDs on regardless of the quantity of light from the LEDs. It is therefore possible to match the actual quantity of light from the LEDs at present with the actual quantity of light when the LEDs are on under the conditions for generating the white reference data by correcting the reference light quantity based on the modulated light calculated based on the present output and the target output. It is also possible to fix brightness distribution in the main scanning direction of the linear illumination. If there is one item of white reference data based on the brightness distribution in the main scanning direction, it is possible to carry out shading correction that reduces the influence of the brightness distribution in the main scanning direction of the light source. It is therefore possible to reduce the influence of brightness distribution of the light source without updating the white reference data. As a result, it is sufficient to only correct the reference light quantities for the LEDs. This increases image reading speed compared to updating of the white reference data to update data corresponding to each image-sensing element of the image sensor (CCD).

The image reading apparatus of the present invention can generate modulated light image data and can read image data during correction of each reference light quantity. It is therefore possible to modulate light from a plurality of LEDs even while scanning the original P. Scanning by the CCD is therefore not paused in order to update white reference data during scanning of the original and the image reading speed can be increased. It is also possible to generate read image data corresponding to an original as a single item of data regardless of the length in the sub-scanning direction of the original.

With the image reading apparatus of the present invention, the white reference data is stored in the white reference data storage unit that has a plurality of LEDs, the light guide member, the LED control unit, the image-sensing sensor, and the image data generating unit formed integrally. The white reference data varies depending on the characteristics. This has a corresponding effect on the plurality of LEDs and image sensors subject to the influence of the white reference data. By adopting this integrated structure, reference data generated using the plurality of LEDs and image sensors of a single structure can be stored in advance in the white reference storage unit. This means that the structure as a whole is changed when there is damage to the LEDs or CCDS, etc. It is therefore not necessary to update white reference data and the repair time at the time of failure can be shortened.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image reading apparatus comprising:
a plurality of LEDs;
a light guide member that linearly irradiates light incident due to turning on of the LEDs;
an LED control unit that controls light of the plurality of LEDs based on the plurality of LEDs being respectively on and off and based on reference light quantities corresponding to the plurality of LEDs;
an image sensor that scans a document in a main scanning direction when the plurality of LEDs are on at the same time;
a relative movement unit that scans the document in a sub-scanning direction using the image sensor by relative movement of the image sensor and the document;
an image data generating unit that generates read image data corresponding to the document scanned by the image sensor;
a light modulation reference member disposed at a position where scanning by the image sensor is possible;
a target output storage unit that stores target outputs corresponding to the plurality of LEDs in advance; and
a light correction unit that corrects the reference light quantities,
wherein, during correction of each reference light quantity,
the LED control unit puts the plurality of LEDs on individually, and
the light correction unit modulates light of the plurality of LEDs by calculating modulated light quantities based on a present output based on modulated light image data generated by scanning the modulated light reference member when each of the LEDs are on and the stored target outputs corresponding to the LEDs that are on, and correcting the reference light quantities corresponding to the LEDs that are on based on the calculated modulated light quantities.

2. The image reading apparatus according to claim 1, wherein the LED control unit controls the quantity of light of the LEDs using either illumination time or supplied current.

3. The image reading apparatus according to claim 1, wherein during correction of each reference light quantity is from when scanning of the sub-scanning direction by the image sensor of the document ends to when the document is transported to a position where scanning by the image sensor is possible,
the LED control unit puts LEDs other than the LED corresponding to the reference light quantity to be corrected off during correction of each reference light quantity, and
the light correction unit corrects the reference light quantity corresponding to the LED that is on.

4. The image reading apparatus according to claim 1, wherein the image sensor is formed with a reference region, differing from a medium region, scanning the document while the document is transported to opposite the image sensor by the relative movement unit, and
the light modulation reference member is disposed further to the image sensor side than the document and is disposed at a position at the reference region where scanning is possible while the document is transported to a location facing the image sensor by the relative movement unit.

5. The image reading apparatus according to claim 4, wherein a line exposure time during scanning by the image sensor is set to two times a minimum exposure time of the image sensor,
the image sensor is exposed two times in one scan during correction of each reference light quantity,
the LED control unit puts the LEDs on to correct the reference light quantities during one of the two exposures, and puts the plurality of LEDs on simultaneously during the remaining exposure,
the image data generating unit generates the modulated light image data corresponding to one of the two exposures, and generates the read image data corresponding to the remaining exposure, and
the light correction unit calculates a present output based on portions, of the modulated light image data, corresponding to the reference regions.

6. The image reading apparatus according to claim 5, wherein the LED control unit makes a maximum illumination time one half or less of the line exposure time when the light of the LEDs is controlled using the illumination time.

7. The image reading apparatus according to claim 5, wherein the image data generating unit shifts output of the read image data by one bit when controlling the light of the LEDs using the supplied current.

8. The image reading apparatus according to claim 1, further comprising:
a shading correction unit that corrects shading of the read image data; and
a white reference data storage unit that stores white reference data used during shading correction in advance,
wherein the plurality of LEDs, the light guide member, the LED control unit, the image sensor, the image data generating unit, and the white reference data storage unit are formed integrally.
